(19) United States
(12) Patent Application Publication
(10) Pub. No.: US 2010/0036906 A1
(43) Pub. Date: Feb. 11, 2010

(54) ADVERTISEMENTS FOR STREAMING MEDIA

(75) Inventors: Sheng Song, Sunnyvale, CA (US); Jeffrey D. Oldham, San Jose, CA (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 12/185,977

(22) Filed: Aug. 5, 2008

(51) Int. Cl. G06F 15/16

(52) U.S. Cl. 709/203

(57) ABSTRACT

Systems and methods for streaming media content. Streaming media advertising systems can identify a request for streaming media and identify content for presentation to a client requesting the streaming media. The identified content items can be presented simultaneous to presentation of the streaming media or can be interspersed within the presentation of the streaming media.

### BACKGROUND

This disclosure is related to information presentation.

Internet publishers provide streaming media in an effort to compete with other publishers. However, streaming media can be more expensive to provide because of increased bandwidth required to provide such content. Moreover, traditional advertising models are difficult to apply to streaming media.

### SUMMARY

Systems, methods and computer readable media for providing content in association with streaming media are provided. Example systems can include an interface, a content criteria extraction module, and a content matching module. The interface can identify a streaming media based upon a request for the streaming media received from a user. The content criteria extraction module can identify content criteria associated with the streaming media. The content criteria can specify criteria for selection of content that can be provided with the streaming media. The content matching module can identify one or more content items that most closely match the content criteria, including one or more simultaneous content items. The simultaneous content items being displayable simultaneous to display of the streaming media. The interface can provide the one or more simultaneous content items during presentation of the streaming media to a user.

Example methods can include: identifying a request for a streaming media, the request being originated by a client device associate with a user; receiving the streaming media; identifying content criteria associated with the streaming media, the content criteria specifying criteria for selecting content that can be provided with the streaming media; identifying one or more content items that most closely match the content criteria, the content items comprising one or more simultaneous content items, the simultaneous content items being operable to be displayed during display of the streaming media; and, providing the streaming media and the one or more simultaneous content items to the user for presentation during presentation of the streaming media.

Other example methods for streaming media advertising can include: receiving streaming media; providing tags for the streaming media; receiving notification of presentation of the streaming media; identifying advertisements based upon advertisement criteria associated with the streaming media; performing an auction for the identified advertisements; and responsive to the auction, providing advertisements for presentation during the streaming media. Other implementations are disclosed, including implementations directed to systems, methods, apparatuses, computer-readable mediums and user interfaces.

### BRIEF DESCRIPTION OF DRAWINGS

FIG. 1 is a block diagram of an example network architecture that can provide a streaming media advertising system.

FIG. 2 is a block diagram of an example streaming media advertising system.

FIGS. 3 and 4 are block diagrams of other example streaming media advertising systems.

FIG. 5 is a flowchart of an example method for providing advertisements for streaming media.

FIG. 6 is a flowchart of another example method for providing advertisements for streaming media.

### DETAILED DESCRIPTION

Streaming media content delivery systems can provide content (e.g., advertisements) for presentation with the presentation of streaming media. While reference is made throughout this document to the presentation of ads, the streaming media content delivery system proposed can deliver other forms of content including other forms of sponsored content. Advertisements for presentation with the streaming media can be selected based upon advertisement criteria associated with the streaming media. The advertisement criteria, for example, can include media type (e.g., graphic, text, video, audio, etc.) as well as targeting information (e.g., topic, demographic, etc.).

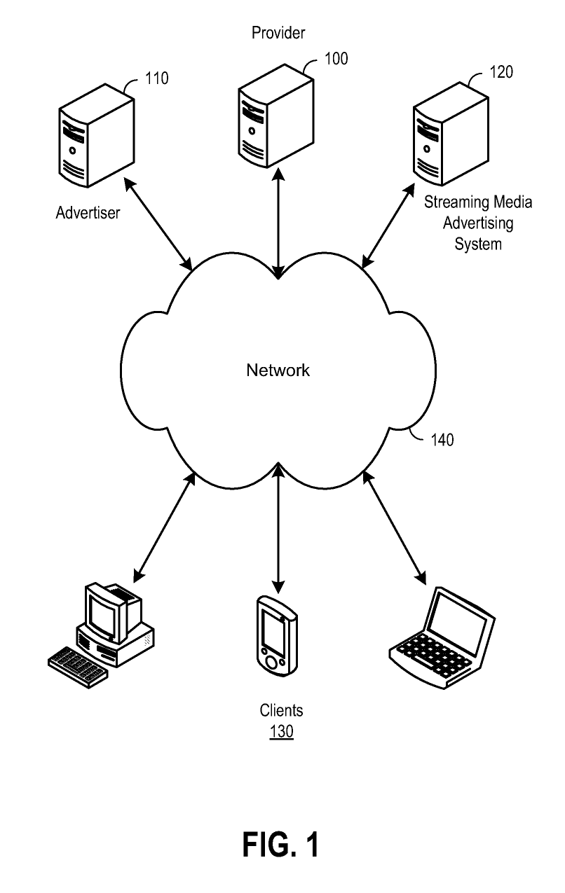

FIG. 1 is a block diagram of an example network architecture that can provide a streaming media advertising system. As shown the example architecture can include a publisher 100, an advertiser 110, a streaming media advertising system 120, user device(s) 130 and a network 140. The publisher 100 can provide content to the user device(s) 130. The content distributed by the publisher 100 can include any content operable to be distributed through the network. In various examples, the content can be distributed using hypertext transfer protocol.

In some implementations, the publisher 100 can provide content to user device(s) 130 that request content from the publisher 100 through a network 140. For example, a user device 130 might request a news service such as CNN or ESPN to receive news stories or sports scores. In some implementations, the publisher can provide streaming media feeds. For example, the publisher can provide video, audio or multimedia feeds to the client(s) 130. The feeds can be provided using a real time streaming protocol (RTSP), a real-time transport protocol (RTP), and/or a real-time transport control protocol (RTCP). Other protocols can be used to provide for streaming media transfer.

In some implementations, the publisher 100 can derive revenue for providing the content based upon advertisements provided to the user device(s) 130 with the streaming media. In such implementations, the streaming media can be supplemented by inserting an interspersed advertisement(s) within the streaming media. For example, interspersed advertisements can be of a same media type as the streaming media and can be inserted into the streaming media at predefined intervals.

Alternatively, the publisher 100 can supplement the content by providing simultaneous advertisements. A simultaneous advertisement can be inserted into a streaming document using an information format consumed by different senses than the streaming document. For example, a visual advertisement can be added to an audio streaming document so both can be consumed simultaneously without their interference. As such, typically, audio advertisements are not added to video streaming documents because video often includes audio. Simultaneous advertisements can be of a different media type than the streaming media, and can be presented during the display of the streaming media. For example, if the streaming media is video, the simultaneous advertisement can be a graphical advertisement, so as not to conflict with the presentation of the streaming media. In another example, if the streaming media is audio, the simultaneous advertisement can be a video or graphical advertisement that does not include audio.

Advertisements can be supplied to the publisher 100 by a streaming media advertising system 120. In some implementations, the advertisement selected for inclusion with the streaming media can be based upon the content of the streaming media being served to the user device(s) 130. For example, if the content being served to the user includes football scores or highlights, selected interactive text message advertisement(s) could be presented that relate to football (e.g., sporting goods stores, football tickets, team apparel, etc.).

In another implementation, the content can be associated with a demographic, and an advertisement can be selected based upon the demographic associated with the content of the streaming media. For example, if the content being served to the user is related to skateboarding, the demographic associated with skateboarding might be suburban teenagers. Suburban teenagers would probably not be interested in, for example, furniture advertisements, but might instead be interested in retailers that cater to their demographic.

In some implementations, the streaming media advertising system 120 can select an advertisement based upon a geographic area associated with the user(s). For example, if the client 130 is located in Washington, DC, service providers in Chicago, Ill., would probably not be of interest to the client 130. In contrast, service providers located in Washington, DC, or surrounding areas might be of interest to the client 130. Thus, the streaming media advertising system 120 can take into account a geographic location associated with the client(s) 130.

In some implementations, the streaming media advertising system 120 can select an advertisement for inclusion with the streaming media based upon a media type associated with the streaming media. In some implementations, the streaming media advertising system 120 can select an advertisement for inclusion with the streaming media content based upon whether the publisher 100 prefers interspersed advertisements or simultaneous advertisements. In some implementations, the advertisement can be selected based upon both the media type associated with the streaming media and the preference of the publisher 100 for interspersed or simultaneous advertisements. For example, the publisher may prefer presentation of simultaneous advertisements. Simultaneous advertisements, in some implementations, are provided in a different media type than the media type associated with the streaming content. For example, if the streaming media is video, the simultaneous advertisement can be a graphical advertisement. In another example, if the streaming media is audio, the simultaneous advertisement can be a video advertisement that does not include audio.

In some implementations, the streaming media advertising system 120 can provide tags to the publisher for inclusion with the streaming media. In some implementations, the tags can include scripts. Upon serving the streaming media with the provided tags, the script included in the tags can cause a client device associated with the client 130 to issue a request for an advertisement to the streaming media advertising system 120. The streaming media advertising system 120 can provide an advertisement in response to receiving the request for an advertisement from the client device associated with the client 130.

In some implementations, the publisher can use the tags to identify insertion points within the streaming media. A player can signal a browser upon encountering the insertion points. In response to receiving the signal from the browser indicating an insertion point has been encountered, the browser can execute the tag provided by the streaming media advertising system 120. In some implementations, the tags can cause the browser to retrieve an advertisement directly from the streaming media advertising system 120. Such automatic retrieval of interspersed or simultaneous advertisements can facilitate inclusion of advertisements without stitching the advertisements directly into the streaming media. Stitching advertisements into a streaming media can include identifying insertion points in a streaming document, and inserting the advertisement into the streaming document at the insertion points.

The advertisements can be created by an advertiser 110. The advertiser 110, in some implementations, can use an advertisement creation interface to interact with the streaming media advertising system 120 to create an advertisement. Selection of the advertisement can initiate a request for a landing page to be served to the user device 130. The landing page can provide information to the user device 130 about a product or service provided by the advertiser 110.

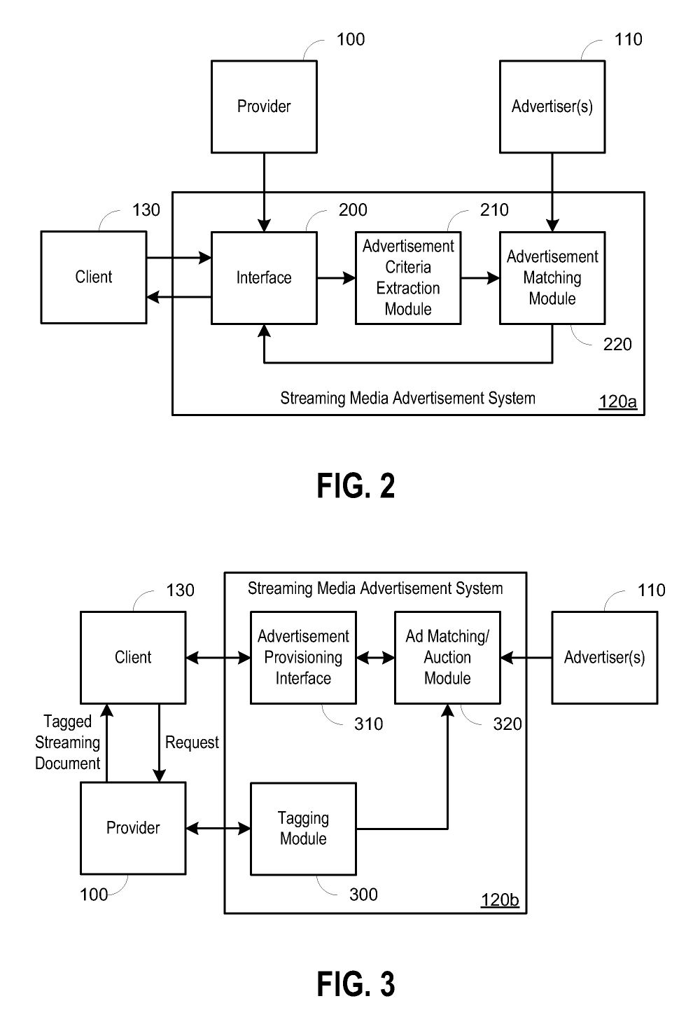

FIG. 2 is a block diagram of an example streaming media advertising system 120a. In some implementations, the streaming media advertising system 120a can include an interface 200, an advertisement criteria extraction module 210 and an advertisement matching module 220. The interface 200 can receive communications from a client 130 requesting streaming media provided by a publisher 100.

In some implementations, the interface 200 can retrieve the streaming media requested by the user from the publisher 100. In such implementations, the streaming media advertising system 120 can serve the streaming media to the client 130. The interface 200 can also forward the streaming media retrieved from the publisher 100 to an advertisement criteria extraction module 210.

The advertisement criteria extraction module 210 can examine the streaming media to identify advertisement criteria associated with the streaming media. Advertisement criteria can include, for example, advertisement insertion points at which interspersed advertisements can be inserted into the streaming media. Insertion points can be identified by the advertisement criteria extraction module 210. In some implementations, the advertisement insertion points can be inserted into the streaming media by the publisher 100. In other implementations, the advertisement criteria extraction module 210 can insert the advertisement insertion points into the streaming media, for example, at points identified by users or administrators associated with the streaming media advertising system 120a.

The advertisement criteria extraction module 210 can also extract characteristics of the streaming media to identify, for example, a demographic associated with the streaming media. In some implementations, the streaming media can be accompanied by tags. In some implementations, the tags can include metadata that describe the content of the streaming media. The tags can be used to identify advertisement criteria for advertisements that can be included with the streaming media. In some examples, the publisher 100 can author the tags to provide advertisement criteria for the streaming media advertising system 120a. In some implementations, the content of the streaming media can be examined and advertisement criteria can be extracted directly from the content of the streaming media.

In some implementations, the advertisement criteria can be based upon the demographic associated with the user of the client 130. In some implementations, specific information identifying the user is not collected (e.g., without user permission); however, demographic information identifying general characteristics can be used to identify advertisement criteria associated with the presentation of the streaming media. In some examples, the demographic information can include age range, gender, and/or identification of a general geographic area associated with the user of the client 130, among others. Geographic area information can be used to screen advertisements that are not suitable for the geographic area in which the user of the client 130 resides. For example, if the client device is located in Madison, Wis., an advertisement for products or services located in Galveston, Tex., are probably unhelpful to the user associated with the client 130 requesting the streaming media.

The advertisement matching module 220 can use the advertisement criteria to determine which of a plurality of advertisements received from advertisers 110 provide the best match for the streaming media based upon the advertisement criteria. For example, if the advertisement criteria identify a demographic associated with the user requesting the streaming media, and the advertisement criteria also provide for graphic advertisement(s) shown simultaneous (e.g., in parallel) to the streaming media, the advertisement matching module 220 can select one or more graphic advertisements associated with the demographic.

The selected advertisement(s) can be provided to the interface 200 for inclusion with the streaming media for communication to the client 130. The selected advertisement(s) can include interspersed advertisements. The interface 200, in some implementations, can stitch the advertisements into the streaming media. In other implementations, the streaming media can be provided to the client 130 and at identified insertion points, any interspersed advertisements can be provided to the client 130. At the completion of the interspersed advertisements, the interface can continue to provide the streaming media.

The interface 200 can also provide the simultaneous advertisements to the client 130. The simultaneous advertisements can be inserted into a content holder (e.g., webpage) associated with the streaming content at a position specified by the publisher (e.g., based upon the web page into which the streaming media is embedded).

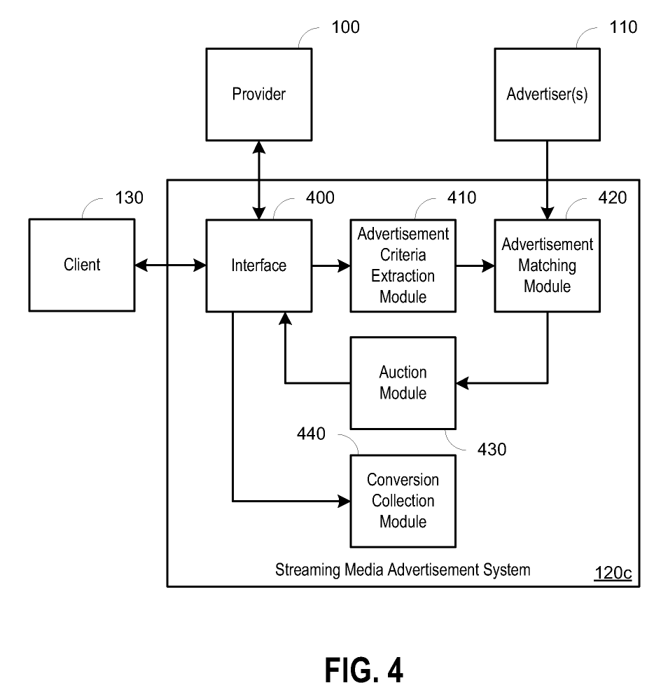

FIG. 3 is a block diagram of an example streaming media advertising system 120b. In some implementations, the streaming media advertising system 120b can include a tagging module 300, an advertisement provisioning interface 310 and an advertisement matching/auction module 320. The tagging module 300 can operate to tag streaming media provided by a publisher 100. The tagged streaming media can be returned to the publisher 100. Upon receiving a request for the streaming media from a client 130, the publisher 100 can provide the tagged streaming media to the client 130. When executed by a client 130, the tags can operate to instruct the client 130 to request advertisements from a streaming media advertising system 120. The request can include advertisement criteria associated with the streaming media, for example, based upon the tags provided by the tagging module 300.

Requests from the client 130 for advertisements can be received by the advertisement provisioning interface 310. The advertisement provisioning interface 310 can communicate the request to an advertisement matching/auction module 320. In some implementations, the advertisement matching/auctioning module 320 can determine which of the advertisements received from an advertiser(s) 110 best match the request. The determination of which advertisements best match the request can be made based upon advertisement criteria included with the request.

In some implementations, the advertisement matching/auction module 320 can perform an auction with matching advertisements. For example, the advertisement matching/auction module 320 can identify those advertisements that provide a threshold match to advertisement criteria. The advertisement matching/auction module 320 can then identify bids associated with those advertisements identified as a threshold match to the advertisement criteria. The advertisement matching/auction module 320 can then analyze the bids to determine which of the advertisements produces a most attractive bid (e.g., the highest bid). In those instances where more than one advertisement is requested, the advertisement matching/auction module 320 can identify multiple advertisements that can be served to the client.

In some implementations, identified multiple advertisements can be provided to the client 130 together as a group of advertisements to be displayed during the display of the streaming media. In other implementations, the tags can cause the client to request advertisements in sequence (e.g., every time a tag is encountered in the streaming media). In such implementations, the advertisement matching/auction module 320 can keep track of advertisements previously served to the client 130 and optionally avoid serving an advertisement to the client 130 more than once during a session.

Once the advertisement matching/auction module 320 has selected an advertisement, the selected advertisement can be returned to the advertisement provisioning interface 310. The advertisement provisioning interface 310 can return the selected advertisement to the client 130.

FIG. 4 is a block diagram of an example streaming media advertising system 120c. In some implementations, the streaming media advertising system 120c can include an interface 400, an advertisement criteria extraction module 410, an advertisement matching module 420, an auction module 430, and a conversion collection module 440. The interface 400 can operate to receive requests for streaming media from clients 130.

In some implementations, the interface 400 can retrieve the streaming media requested by the client 130. The interface 400 can supply the streaming media to the advertisement criteria extraction module 410. The advertisement criteria extraction module 410 can extract the criteria from the streaming media and forward the advertisement criteria to the advertisement matching module 420.

The advertisement matching module 420 can identify those advertisements received from advertisers that best match the advertisement criteria received from the advertisement criteria extraction module. In some implementations, identification of the advertisements best matching the advertisement criteria can be provided to an auction module 430. The auction module can perform an auction using bids associated with the identified advertisements. The auction can select one or more advertisements, for example, based on those projected to maximize profit for the publisher 100, and provide those advertisements to the interface 400.

The interface can provide the selected advertisements and the streaming media to the client 130. In some instances, the client 130 might select the advertisements. In such instances, the client can communicate the selection back to the interface 400 of the streaming media advertising system 120c. The interface 400 can communicate the conversion information to a conversion collection module 440. The conversion collection module 440 can store information associated with the conversion, including, for example, a date and time, an advertisement identification, winning bid amount, and an identification of the streaming media with which the advertisement was served. In some examples, a demographic associated with the user can be identified and recorded. In such examples, personal information identifying the user of the client 130 can be masked or removed from the recorded data such that it is unavailable to administrators of the streaming media advertising system 120c or advertisers 110.

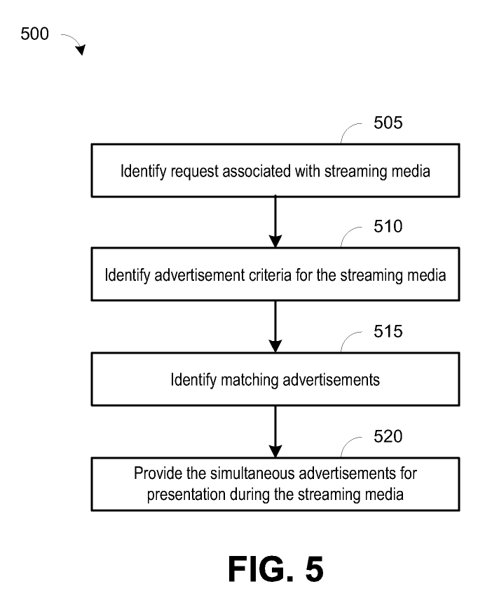

FIG. 5 is a flowchart of an example method 500 for providing advertisements for streaming media. At stage 505 a request associated with the streaming media is identified. The request associated with the streaming media can be identified, for example, by an interface (e.g., interface 200 (FIG. 2), 400 (FIG. 4), or advertisement provisioning interface 300 (FIG. 3)). The request can be originated by a client device associated with a user. In some implementations, the request is received directly from the client. In other implementations, the request can be received indirectly, for example, through a provider of the streaming media.

At stage 510, advertising criteria associated with the streaming media are identified. The advertising criteria associated with the streaming media can be identified, for example, by an advertisement criteria extraction module (e.g., advertisement criteria extraction module 210 (FIG. 2), 410 (FIG. 4)). The advertisement criteria can provide specifications for advertisements to be provided with the streaming media. In various implementations, the advertisement criteria can be extracted from tags associated with the streaming media, can be extracted from the request, or can be extracted from the content of the streaming media, among others.

At stage 515, matching advertisements can be identified. Matching advertisements can be identified, for example, by an advertisement matching module (e.g., advertisement matching module 220 (FIG. 2), 320 (FIG. 3), or 420 (FIG. 4)). In some implementations, the advertisements that most closely match the advertisement criteria are identified based upon the advertisement criteria extracted at stage 510. The matching advertisements can include one or more simultaneous advertisements operable to be displayed during display of the streaming media.

At stage 520, the simultaneous advertisements can be provided for presentation during presentation of the streaming media. The advertisements can be provided, for example, by an interface (e.g., interface 200 (FIG. 2), 400 (FIG. 4), or advertisement provisioning interface 310 (FIG. 3)). In some implementations, the simultaneous advertisements can be provided as an overlay to the streaming media. For example, the advertisement can be included within the streaming content provided to the user in the form of a crawler or logo or other advertisement form within the streaming content. In other implementations, the simultaneous advertisements can be provided to the client for presentation, for example, alongside the streaming media based upon the hypertext code specifying the web page to be displayed on a client device.

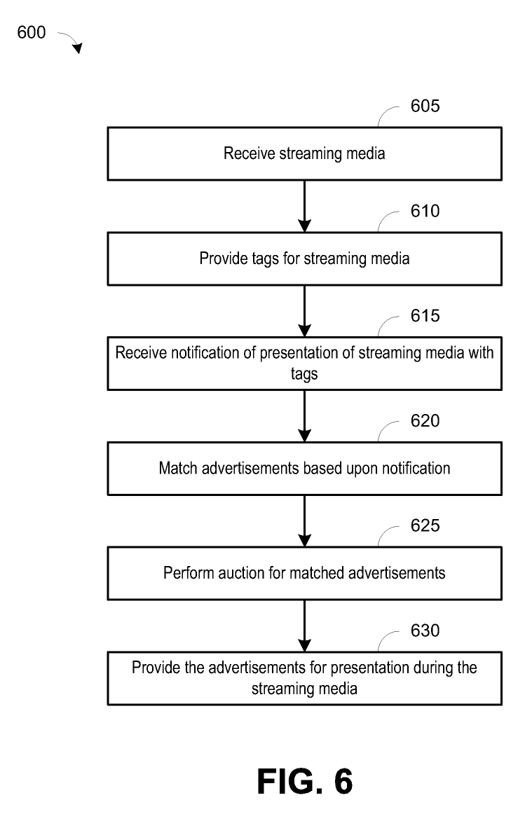

FIG. 6 is a flowchart of another example method 600 for providing advertisements for streaming media. At stage 605, streaming media is received. The streaming media can be received, for example, by a tagging module (e.g., tagging module 300 of FIG. 3) from a provider (e.g., publisher 100 of FIG. 3). In some implementations, the provider can specify advertisement criteria for the streaming media. In other implementations, advertisement criteria for the streaming media can be automatically identified based upon the content of the streaming media or metadata associated with the streaming media.

At stage 610, tags for the streaming media can be provided. The tags for the streaming media can be provided, for example, by the tagging module (e.g., tagging module 300 of FIG. 3). In some implementations, the tags can encode the advertisement criteria for the streaming media and can be operable to communicate the advertisement criteria to a streaming media advertising system when a web page presenting the streaming media is executed by a client.

At stage 615, notification of presentation of streaming media with tags is received. The notification of presentation of streaming media with tags can be received, for example, by an advertisement provisioning interface (e.g., advertisement provisioning interface 310 of FIG. 3). In some implementations, the notification includes a request for an advertisement to be served alongside the streaming media. The request can include the advertisement criteria (e.g., including size, duration, content, geographic location, etc.).

At stage 620, matching advertisements can be identified based upon the notification. The matching advertisements can be identified, for example, by an advertisement matching module (e.g., advertisement matching/auction module 320 of FIG. 3). Advertisements can be matched based upon a relevance metric when compared to the advertisement criteria. In some implementations, advertisement criteria can be stored locally by a tagging module (e.g., module 300 of FIG. 3) when the streaming media is tagged. In other implementations, a metadata portion of the tags describing the content and/or advertisement preferences can be communicated back to the streaming media advertising system when notification of presentation of the streaming media is provided to the advertisement provisioning interface. Such metadata can be used to select suitable advertisements for the streaming media.

At stage 625, an auction for matched advertisements is performed. The auction for matched advertisements can be performed, for example, by an auction module (e.g., advertisement matching/auction module 320 of FIG. 3). In some implementations, the auction module can analyze bids associated with each of the matched advertisements and select a bid that is projected to maximize revenue for the publisher.

At stage 630, advertisements are provided for presentation during presentation of the streaming media. The advertisements can be provided, for example, by an advertisement provisioning interface (e.g., advertisement provisioning interface 310 of FIG. 3). In some implementations, the advertisements provided for presentation can include simultaneous advertisements which can be presented simultaneously with the content of the streaming media. Simultaneous advertisements can be provided in a media type different from the media type in which the streaming media is provided. In other implementations, the advertisements provided for presentation can include interspersed advertisements which can be presented at predefined insertion points within the streaming media. Interspersed advertisements can be presented in a media type identical to the media type associated with the streaming media, or in a different media type from the media type associated with the streaming media.

The various aspects of the subject matter described in this specification and all of the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject matter of this specification has been described in terms of particular embodiments, but other embodiments can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims. The same experimental techniques work for any web page, not merely advertising landing pages. Any web site owner can experimentally determine how good his or her web site design is and which web pages should be targeted for improvement. The web site owner merely needs to designate a test page and a goal page. A goal rate can be calculated as the percentage of browsing users who, having reached the test page, go on to reach the goal page. The goal rate can be interpreted as a measure of success. In this specification, in order to adopt the commonly used terminology, “landing page” is used to include all test pages whether or not arrived at through an advertisement, and “conversion page” is used to include all goal pages.

These and other implementations are within the scope of the following claims.

What is claimed is:

1. A computer-implemented method, comprising:
identifying a request associated with a streaming media, the request being originated by a client device associated with a user;
identifying content item criteria associated with the streaming media, the content item criteria specifying criteria for selecting one or more content items that can be provided with the streaming media;
identifying one or more content items that match the content item criteria, the content items comprising one or more simultaneous content items, the simultaneous content items being operable to be displayed simultaneously to display of the streaming media, the simultaneous content items comprising a different media type than the streaming media; and
providing the streaming media and the one or more simultaneous content items to the user for presentation during presentation of the streaming media.

2. The method of claim 1, further comprising:
determining whether the content item criteria provide for inclusion of simultaneous content items; and
if the content item criteria provide for inclusion of simultaneous content items, identifying one or more simultaneous content items that most closely match the content item criteria; and
provide the one or more simultaneous content items that most closely match the content item criteria to the client device.

3. The method of claim 1, further comprising:
determining whether the content item criteria provide for inclusion of interspersed content items;
if the content item criteria provide for inclusion of interspersed content items, identifying one or more interspersed content items that most closely match the content item criteria; and
provide the one or more interspersed content items that most closely match the content item criteria to the client device.

4. The method of claim 3, wherein the interspersed content items are of the same media type as the streaming media.

5. The method of claim 3, wherein determining whether the content item criteria provide for inclusion of interspersed content items comprises identifying insertion points within the streaming media.

6. The method of claim 1, wherein identifying the content item criteria associated with the streaming media comprises extracting the content item criteria from the streaming media.

7. The method of claim 1, wherein identifying the content item criteria associated with the streaming media are received from a provider of the streaming media.

8. The method of claim 1, further comprising:
performing an auction to identify one or more selected content items from the one or more content items that most closely match the content item criteria;
wherein providing the streaming media and the one or more content items to the user, comprises providing the streaming media and the one or more selected content items to the user.

9. The method of claim 1, further comprising collecting conversion information associated with the user based upon providing the streaming media and the one or more content items to the user.

10. A system, comprising:
an interface operable to identify a streaming media based upon a request for the streaming media received from a user;
a content item criteria extraction module operable to identify content item criteria associated with the streaming media, the content item criteria specifying criteria for selecting one or more content items that can be provided with the streaming media;
a content item matching module operable to identify one or more content items that most closely match the content item criteria, the one or more content items comprising one or more simultaneous content items, the simultaneous content items being operable to be displayed simultaneously to display of the streaming media; and
wherein the interface is further operable to provide the one or more simultaneous content items during presentation of the streaming media to the user.

11. The system of claim 10, wherein the content item matching module is operable to determine whether the content item criteria provide for inclusion of simultaneous content items, the content item matching module being operable to identify one or more simultaneous content items that most closely match the content item criteria if the content item criteria provide for inclusion of simultaneous content items.

12. The system of claim 11, wherein the simultaneous content items are presented in a different media type than the streaming media.

13. The system of claim 10, wherein the content item matching module is operable to determine whether the content item criteria provide for inclusion of interspersed content items, the content item matching module being operable to identify one or more interspersed content items that most closely match the content item criteria if the content item criteria provide for inclusion of interspersed content items.

14. The system of claim 13, wherein the interspersed content item are of the same media type as the streaming media.

15. The system of claim 10, wherein the content item matching module is operable to determine whether the content item criteria provide for inclusion of interspersed content items or simultaneous content items through identification of insertion points within the streaming media.

16. The system of claim 10, wherein the content item criteria extraction module is operable to extract the content item criteria from the streaming media.

17. The system of claim 10, wherein the content item criteria extraction module is operable to received the content item criteria from a provider of the streaming media.

18. The system of claim 10, further comprising:
an auction module operable to perform an auction to identify one or more selected content items from the one or more content items that most closely match the content item criteria; and
wherein the interface is operable to provide the streaming media and the one or more selected content items to the user.

19. The system of claim 10, further comprising a conversion collection module operable to collect conversion information associated with the user based upon providing the streaming media and the one or more content items to the user.

20. A method, comprising:
receiving streaming media;
providing tags for the streaming media, the tags comprising a script portion and a data portion;
receiving the data portion of the tags, the data portion of the tags being received responsive to execution of the script portion of the tags by a user device;
identifying content items based upon content item criteria associated with the streaming media derived from the data portion of the tags;
selecting one or more of the identified content items; and
providing the one or more selected content items to the user device for presentation with the streaming media.

21. The computer implemented method of claim 20, wherein selecting one or more of the identified content items comprises:
performing an auction for the identified content items; and
selecting one or more of the identified content items responsive to the auction.

22. The method of claim 20, further comprising providing the one or more selected content items without stitching the content items into the streaming media.
